(19) United States
(12) Patent Application Publication
(10) Pub. No.: US 2016/0254030 A1
(43) Pub. Date: Sep. 1, 2016

(54) DISK DRIVE MODULE

(71) Applicant: HEWLETT-PACKARD ENTERPRISE DEVELOPMET LP, Houston, TX (US)

(72) Inventors: Earl W Moore, Cypress, TX (US); Minh H Nguyen, Katy, TX (US)

(21) Appl. No.: 15/033,581

(22) PCT Filed: Feb. 5, 2014
(86) PCT No.: PCT/US2014/014840

§ 371 Date: Apr. 29, 2016

(51) Int. Cl. G11B 33/02

(52) U.S. Cl. CPC G11B 33/022

(57) ABSTRACT

A disk drive module is provided herein. The disk drive module includes a set of rail members formed on two opposing sides of a frame, and a retaining wall extending between the set of rail members with a retention member extending therefrom. A paddle member is positioned adjacent to the retention member. A hook member is connected to the paddle member and rotates about an axis between an engaged position and an unengaged position based on an amount of force applied to the paddle member.

### BACKGROUND

Computing systems include hard disk drives. The hard disk drives are typically attached to a hard disk drive carrier then inserted into a computing system. For example, a hard disk drive is attached to a hard disk drive carrier and then inserted into a shelf in a computing system where it is connected to other electronic components.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a disk drive module according to an example;

FIGS. 2A-2B illustrate isometric views of the disk drive module of FIG. 1 according to an example;

FIG. 3 illustrates a top view of the disk drive module of FIG. 1 according to an example;

FIG. 4 illustrates a bottom view of the disk drive module of FIG. 1 according to an example;

FIG. 5 illustrates a block diagram of a system according to an example; and

FIGS. 6-7 illustrate perspective views of the system of FIG. 5 according to examples.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Computing system designs determine requirements for components in the computing system. Space, thermal constraints, cost, and ease of use are some factors that determine the type of hard disk drive carriers that are used in a specific computing system.

In examples, a disk drive module is provided. The disk drive module includes a frame, a set of rail members, a retaining wall, a retention member, a paddle member, and a hook member. The retention member extends from the retaining wall. The paddle member is positioned adjacent to the retention member, such that, contact with the retention member to apply a force to the paddle member. The hook member is connected to the paddle member. The hook member to rotate about an axis between an engaged position and an unengaged position based on an amount of the force applied to the paddle member. The disk drive module is insertable into both a top loading chassis and a front loading chassis.

The phrase “disk drive” refers to a device to read data from and write data to a disk. For example, a hard disk drive uses a program to read data from and write data to a disk.

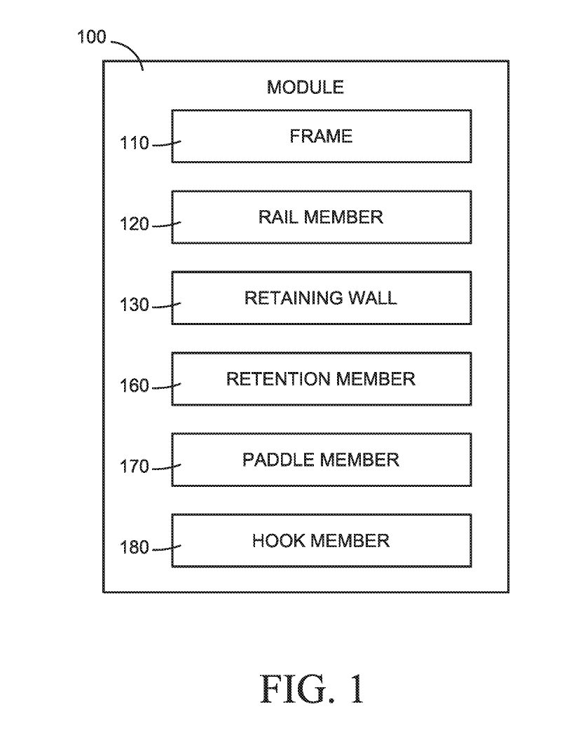

FIG. 1 illustrates a block diagram of a disk drive module 100 according to an example. The disk drive module 100 includes a frame 110, a set of rail members 120, a retaining wall 130, a retention member 160, a paddle member 170, and a hook member 180. The set of rail members 120 are formed on two opposing sides of the frame 110. The retaining wall 130 extends between the set of rail members 120. The retention member 160 extends from the retaining wall 130. The paddle member 170 is positioned adjacent to the retention member 160.

Contact with the retention member 160 to apply a force to the paddle member 170. The hook member 180 is connected to the paddle member 170. The hook member 180 to rotate about an axis between an engaged position and an unengaged position based on an amount of the force applied to the paddle member 170. In the engaged position, no force is applied to the paddle member 170. In the unengaged position, the amount of the force is applied to the paddle member 170.

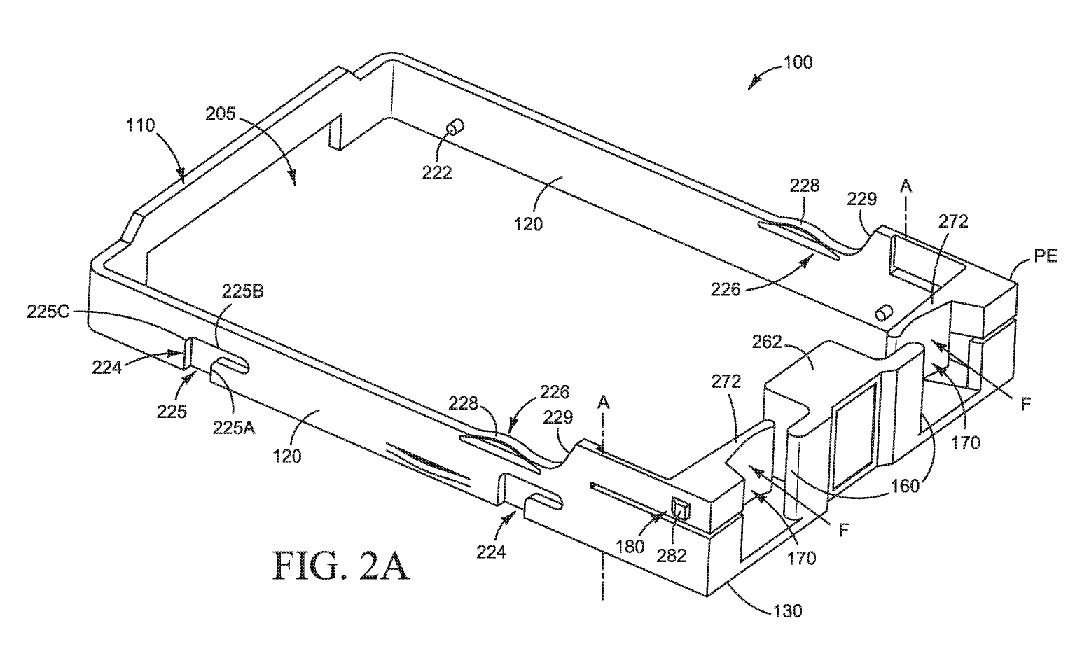

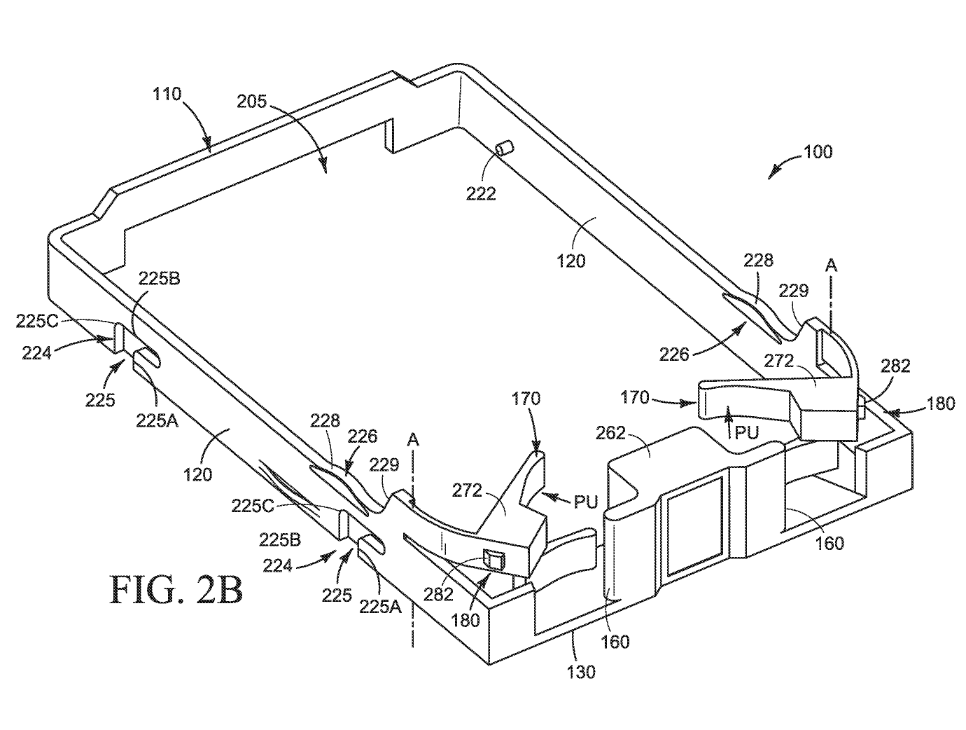

FIGS. 2A-2B illustrate isometric views of the disk drive module 100 of FIG. 1 according to an example. The disk drive module 100 includes the frame 110, the set of rail members 120, the retaining wall 130, the retention member 160, the paddle member 170, and the hook member 180 as discussed with reference to FIG. 1.

The disk drive module 100 further includes a set of pins 222 extending from the frame 110 to engage with a set of screw holes on a disk drive. The set of pins 222 to hold and/or secure the disk drive in the disk drive module 110. For example, in FIG. 2A, the set of pins 222 are illustrated as extending from or through the rail members 120 into a disk drive opening 205.

The disk drive module 100 also includes a top loading alignment member 224 positioned on at least one of the set of rail members 120. The top loading alignment member 224 as illustrated in FIG. 2A includes a groove 225 positioned on the at least one of the set of rail members 120 formed to engage with a cage fastener. The groove 225 provides compatibility with top loading disk drives. The groove 225 is illustrated having a first portion 225A and a second portion 225B connected at approximately a right angle 225C.

Referring to FIG. 2A, The set of rail members 120 as illustrated include a keyed profile 226 to provide compatibility with a front loading disk drive. The keyed profile 226 includes, for example, a spring connector 228 along each rail member of the set of rail members 120 and a sloped wall 229 between the retention wall 130 and the set of rail members 120. The spring connector 228 to retain the disk drive module 100 in place and prevent upward and downward movement when engaged. The keyed profile 226 and/or spring connector 228 may help to absorb energy from an external shock and vibration which may induce the degradation of the performance of the disk drive.

The retention member 160 includes, for example, a protrusion 262 extending from the retaining wall 130, such as a T-shaped protrusion, as illustrated in FIGS. 2A-2B. The paddle member 170 is illustrated as a pair of paddles 272. The paddle member 170 remains in the engaged position, P_{E}, when no force is applied. In the engaged position, P_{E}, the hook member 180 extends from the set of rail members 120, as illustrated in FIG. 2A. The hook member 180 is illustrated as a pair of hooks 282.

Referring to FIG. 2B, contact with the retention member 160 applies a force, F, to the paddle member 170. The force, F, applied to the paddle member 170 moves the paddle member 170 inward to an unengaged position, P_{U}, as illustrated in FIG. 2B. In the unengaged position, P_{U}, the hook member 180 also rotates or deflects inward about an axis A and towards a disk drive. For example, the pair of paddles 272 as illustrated is formed from the frame 110; however, the pair of paddles 272 may also be a separate member connected or attached to the frame 110.

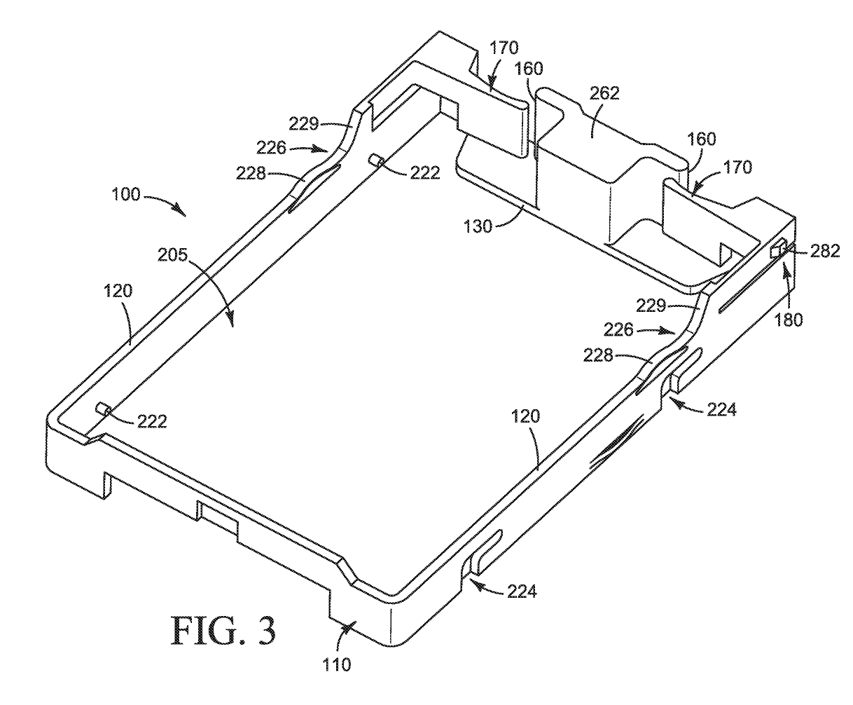

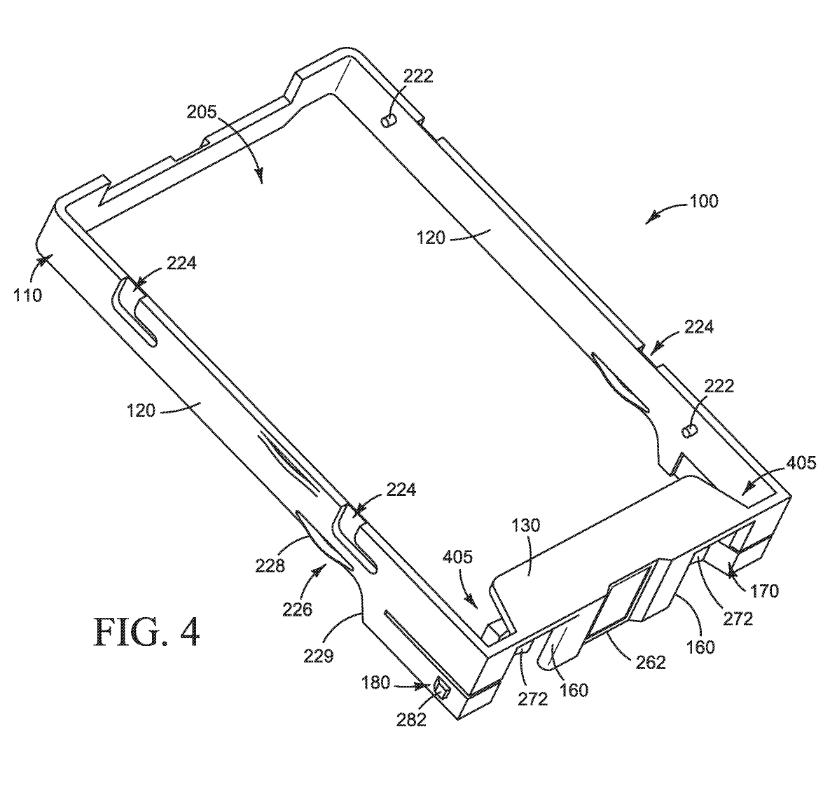

FIG. 3 illustrates a top view of the disk drive module of FIG. 1 according to an example. FIG. 4 illustrates a bottom view of the disk drive module of FIG. 1 according to an example. FIGS. 3-4 include isometric views of the frame 110, the set of rail members 120, the set of pins 222, the top loading alignment members 224, the grooves 225, the keyed profile 226, the retaining wall 130, the retention member 160 as a protrusion 262, the paddle member 170 illustrated as a pair of paddles 272, and the hook member 180 illustrated as a pair of hooks 282. The paddle member 170 and the hook member 180 are both illustrated in the engaged position, P_{E}. As FIGS. 3-4 illustrate, the disk drive module 100 provides a tool-less drive installation by shaping the frame 110 to include front corners with flexible openings 405 to stretch the disk drive module 100 around a disk drive. The tool-less drive installation also facilitate retaining the disk drive using the set of pins 222 that engage with the screw holes of the disk drive.

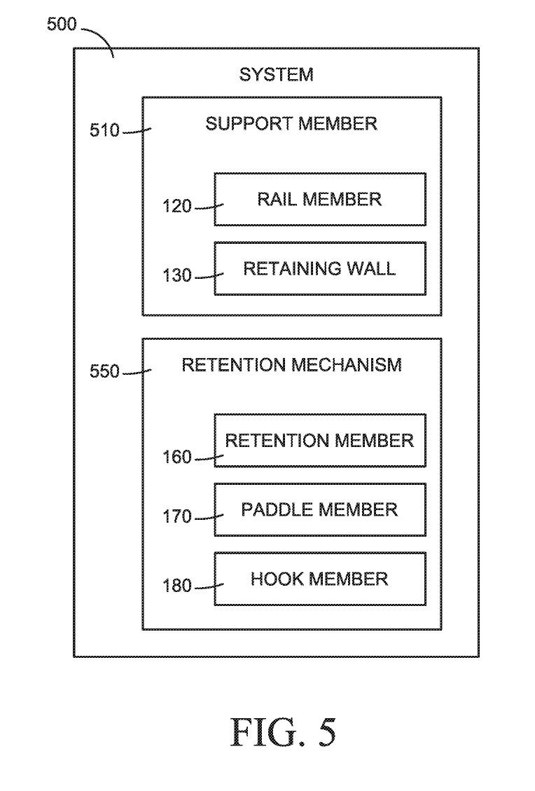

FIG. 5 illustrates a block diagram of a system 500 according to an example. A system 500 includes a support member 510 and a retention mechanism 550. The support member 510 includes a set of rail members 120 and a retaining wall 130. For example, the support member 510 may include or form a frame 110 that is a unitary member. The set of rail members 120 are formed on two opposing sides of the support member 510. The retaining wall 130 extends between the set of rail members 120.

The retention mechanism 550 extends from the support member 120. The retention mechanism 550 includes a retention member 160, a paddle member 170, and a hook member 180. The paddle member 170 is positioned adjacent to the retention member 160. Contact with a retention member 160 to apply a force to the paddle member 170, and the hook member 180 connected to the paddle member 170. The hook member 180 to rotate about an axis between an engaged position and an unengaged position based on an amount of the force applied to the paddle member 170. As illustrated in FIGS. 2A-2B above, in the engaged position, no force is applied to the paddle member 170, and in the unengaged position, the amount of the force is applied to the paddle member 170.

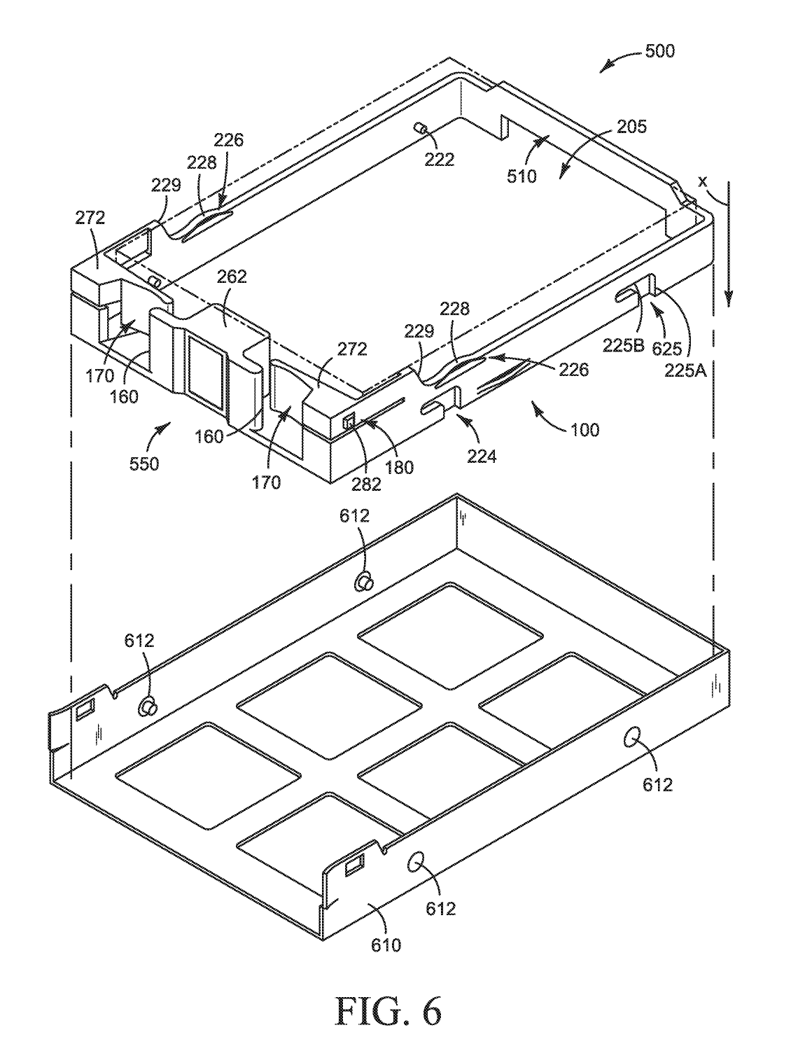

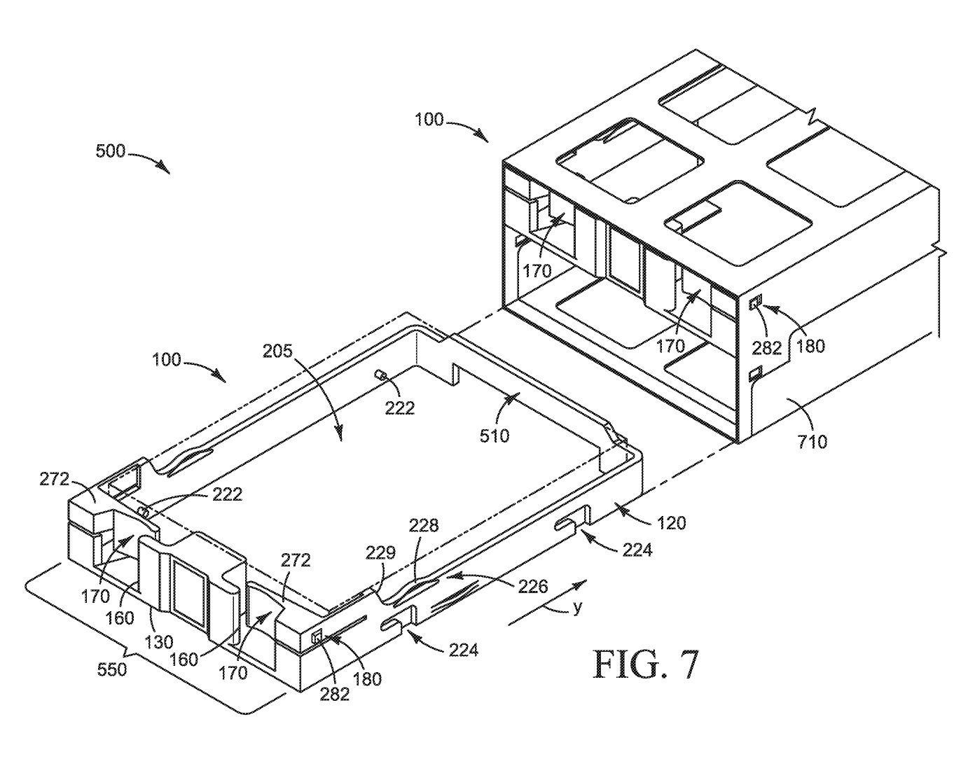

FIGS. 6-7 illustrate perspective diagrams of the system 500 of FIG. 5 according to examples. The system 500 includes the support member 510, the set of rail members 120, a top loading alignment member 224, a keyed profile 226, the retaining wall 130, the retention member 160 as a protrusion 262, the paddle member 170 illustrated as a pair of paddles 272, and the hook member 180 illustrated as a pair of hooks 282. The system 500 also includes a set of pins 222 extending from the support member 510 to engage with a set of screw holes on a disk drive to retain the disk drive therein. For example, the set of pins 222 may extend from or through the set of rail members 120.

The retention member 160 is illustrated to include a handle extending from the support member 120. For example, the handle 160 is formed of a protrusion 262 that extends from the retention member 160. The handle is formed to allow a user to “grab or hold” the handle, which applies a force, F, to the paddle member 170 and rotates or deflects the paddle member 170 inward about an axis A, towards the disk drive or a disk drive opening 205 that is formed to receive the disk drive. The force, F, applied to the paddle member 170 moves the paddle member 170 into the unengaged position, P_{U}, as illustrated in FIG. 2B above. The force applied to the paddle member 170 also causes the hook member 170, which extends from the support member 510, to rotate inward towards a disk drive or a disk drive opening 205 formed in the support member 510. As the hook member 170 rotates inward, the hook member 170 moves into the unengaged position, P_{U}.

The paddle member 170 remains in the engaged position, P_{E}, when no force is applied. In the engaged position. P_{E}, the hook member 180 extends from the set of rail members 120, as illustrated above in FIG. 2A.

Referring to FIG. 6, the system 500 is useable with a top loading disk drive. The top loading alignment member 224 is formed along each rail member of the set of rail members 120 to enable use with the top loading disk drive. The top loading alignment member 224 includes an L-shaped groove 625 formed in each rail member 120. The L-shaped groove 625 formed to receive a cage fastener 612 for top loading installation. For example, in a top loading disk drive assembly, the disk drive module 100 may be installed into a top loading system drive cage 610 by pushing the disk drive module 100 down along a first portion of the groove 225A and then pushing the disk drive module 100 back into the system drive cage 610 along the second portion of the groove 225B. The cage fastener 612 may be positioned along the system drive cage 610, for example two cage fasteners 612 may be positioned opposite one another on two opposing sides of the system drive cage 610. The top loading system drive cage 610 moves up and down along the arrow X.

Referring to FIG. 7, the system 500 is also useable with a front loading disk drive. The system 500 may further include a front loading system drive cage 710. Use of the front loading disk drive with the front loading system drive cage 710 is facilitated by the keyed profile 226 of the disk drive module 100. The keyed profile 226 includes a spring connector 228 along each rail member of the set of rail members 120. The keyed profile 226 also includes a sloped wall 229 between the retention mechanism 550 and the set of rail members 120. The spring connector 228 to retain the disk drive module 100 in place and prevent movement, such as upward and downward movement, when engaged. The keyed profile 226 also facilitates stacking disk drives, as illustrated by the front loading system drive cage 710. In the front loading disk drive example, the disk drive module 100 moves along the arrow Y into and out of the front loading system drive cage 710.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A disk drive module comprising:
a frame;
a set of rail members formed on two opposing sides of the frame;
a retaining wall extending between the set of rail members;
a retention member extending from the retaining wall;
a paddle member positioned adjacent to the retention member, contact with the retention member to apply a force to the paddle member; and
a hook member connected to the paddle member, the hook member to rotate about an axis between an engaged position and an unengaged position based on an amount of the force applied to the paddle member, and
wherein in the engaged position no force is applied to the paddle member, and in the unengaged position the amount of the force is applied to the paddle member.

2. The disk drive module of claim 1, further comprising a set of pins extending from the frame to engage with a set of screw holes on a disk drive.

3. The disk drive module of claim 1, wherein the retention member comprises a protrusion extending from the retaining wall.

4. The disk drive module of claim 1, further comprising a keyed profile to provide compatibility with a front loading disk drive.

5. The disk drive module of claim 1, further comprising a top loading alignment member positioned on at least one of the set of rail members, the top loading alignment member includes a groove positioned on the at least one of the set of rail members formed to engage with a cage fastener.

6. The disk drive module of claim 1, wherein the force applied to the paddle member moves the paddle member inward.

7. The disk drive module of claim 1, wherein in the engaged position the hook member extends from the set of rail members and in the unengaged position the hook member rotates inward.

8. A system comprising:
a support member including
a set of rail members formed on two opposing sides of the support member, and
a retaining wall extending between the set of rail members; and
a retention mechanism that extends from the support member, the retention mechanism includes:
a retention member,
a paddle member positioned adjacent to the retention member, contact with the retention member to apply a force to the paddle member, and
a hook member connected to the paddle member, the hook member to rotate about an axis between an engaged position and an unengaged position based on an amount of the force applied to the paddle member, and
wherein in the engaged position no force is applied to the paddle member and in the unengaged position the amount of the force is applied to the paddle member.

9. The system of claim 8, further comprising a set of pins extending from the support member to engage with a set of screw holes on a disk drive to retain the disk drive therein.

10. The system of claim 8, further comprising a keyed profile usable with a front loading disk drive.

11. The system of claim 8, further comprising a keyed profile to stack disk drives.

12. The system of claim 8, further comprising a top loading alignment member formed along each rail member of the set of rail members, the top loading alignment member including an L-shaped groove formed in each rail member.

13. The system of claim 8, wherein the hook member extends from the support member in the engaged position, and the hook member rotates inward in the unengaged position.

14. The system of claim 8, wherein the force applied to the paddle member causes the paddle member to rotate inward.

15. The system of claim 8, wherein the retention member comprises a handle.
